(19) United States
(12) Patent Application Publication
(10) Pub. No.: US 2026/0158874 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yong Woong Cha, Hwaseong-si (KR); Dongseok Oh, Hwaseong-si (KR); Seong-Bin Jeong, Hwaseong-si (KR); Minseob Shin, Hwaseong-si (KR); Jae Yeon Kim, Hwaseong-si (KR); Jungha Park, Hwaseong-si (KR)

(73) Assignees: HYUNDAI MOTOR COMPANY, Seoul (KR); KIA CORPORATION, Seoul (KR)

(21) Appl. No.: 19/229,807

(22) Filed: Jun. 5, 2025

(30) Foreign Application Priority Data
Dec. 6, 2024 (KR) 10-2024-0180992

(51) Int. Cl. B60H 1/32; B60H 1/00

(52) U.S. Cl. CPC B60H 1/32284; B60H 1/00392; B60H 1/004; B60H 1/00485

(57) ABSTRACT

A heat pump system for a vehicle is provided so that the thermal energy generated from the refrigerant when condensing and evaporating the refrigerant is selectively heat-exchanged with the coolant. The vehicle interior temperature is adjusted by using the heat-exchanged low-temperature or high-temperature coolant. The heating efficiency of the vehicle is improved by selectively using the ambient air heat, the waste heat of the electrical component, and the waste heat of the battery module at the time of heating the vehicle interior. The heating efficiency of the vehicle is further improved by increasing the overall travel distance of the vehicle by efficiently adjusting the temperature of the battery module so that the optimal performance of the battery module may be achieved.

### CROSS-REFERENCE TO RELATED APPLICATION

This application claims priority to and the benefit of Korean Patent Application No. 10-2024-0180992 filed with the Korean Intellectual Property Office on Dec. 6, 2024, the entire contents of which is incorporated herein by reference.

### BACKGROUND

### Technical Field

The present disclosure relates to a heat pump system for a vehicle, and more particularly, the present disclosure relates to a heat pump system for a vehicle capable of improving the heating performance.

### Description of the Related Art

An air conditioning system for a vehicle includes an air conditioner unit circulating a refrigerant in order to heat or cool an interior of the vehicle.

The air conditioner unit, which is to maintain the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environment-friendly vehicle capable of substantially substituting for an internal combustion engine vehicle is required, and the environment-friendly vehicle is classified into an electric vehicle driven using a fuel cell or electricity as a power source and a hybrid vehicle driven using an engine and a battery.

In the electric vehicle or the hybrid vehicle among these environment-friendly vehicles, a separate heater is not used unlike an air conditioner of a general vehicle, and an air conditioner used in the environment-friendly vehicle is generally called a heat pump system.

The electric vehicle driven by the power source of the fuel cell generates driving force by converting chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, the hybrid vehicle generates driving force by driving a motor using electricity supplied from the fuel cell described above or an electrical battery, together with an engine operated by a general fuel. Therefore, heat generated from the fuel cell or the battery and the motor should be effectively removed in order to secure performance of the motor.

Therefore, in the hybrid vehicle or the electric vehicle according to the related art, cooling means, a heat pump system, and a battery cooling system, respectively, should be configured as separate closed circuits so as to prevent heat generation of the motor, an electric component, and the battery including a fuel cell.

Therefore, there is a disadvantage in that the size and weight of the cooling module disposed at the front of the vehicle increase, and the layout of the connecting pipes supplying refrigerant or coolant to the heat pump system, cooling system, and battery cooling system inside the engine room becomes complicated.

In addition, since a battery cooling system is separately provided to warm up or cool down the battery depending on the condition of the vehicle so that the battery can provide an optimal performance, and a number of valves are applied to connect to each connecting pipe, noise and vibration caused by frequent opening and closing of these valves are transmitted to the vehicle interior, which disadvantageously reduces ride comfort.

In addition, since a separate heat-exchanger should be employed in order to recollect the waste heat from various heat sources in the heating mode of the vehicle, there is also the disadvantage of increasing the manufacturing cost.

The above information disclosed in this Background section is only for enhancement of understanding of the background of the disclosure, and therefore it may contain information that does not form the prior art that is already known to a person having ordinary skill in the art.

### SUMMARY

The present disclosure provides a heat pump system for a vehicle in which the thermal energy generated from the refrigerant when condensing and evaporating the refrigerant is selectively heat-exchanged with the coolant, and the vehicle interior temperature is adjusted by using the heat-exchanged low-temperature or high-temperature coolant.

The present disclosure provides a heat pump system for a vehicle capable of improving the heating efficiency of the vehicle by selectively using the ambient air heat, the waste heat of the electrical component, and the waste heat of the battery module at the time of heating the vehicle interior. The heating efficiency of the vehicle contributes to increasing its overall travel distance of the vehicle by efficiently adjusting the temperature of the battery module so that the optimal performance of the battery module may be achieved.

In an embodiment of the present disclosure, a heat pump system for a vehicle includes: a valve module including at least one port through which coolant is introduced or discharged; and a first line configured to allow the coolant flow and including a first end and a second end connected to the valve module, wherein a radiator, an electrical component, and a first water pump are connected to the first line. The heat pump system further includes a second line configured to allow the coolant flow and including a first end and a second end connected to the valve module, wherein a battery module and a first chiller are connected to the second line. The heat pump system further includes a third line configured to allow the coolant flow and including a first end and a second end connected to the valve module, wherein a heating core and a condenser are connected to the third line. The heat pump system further includes a fourth line configured to allow the coolant flow and including a first end and a second end connected to the valve module, wherein a cooling core and a second chiller are connected to the fourth line. The heat pump system further includes a first connection line connecting the first line and the third line, and a second connection line connecting the first line and the fourth line. In particular, based on at least one mode for adjusting a temperature of a vehicle interior and a temperature of the battery module, the valve module is configured to control the flow of the coolant by selectively connecting the first line, the second line, the third line, the fourth line, the first connection line, and the second connection line.

A first end of the first connection line may be connected to the first line between the radiator and the electrical component. A second end of the first connection line may be connected to the third line at a downstream end of the condenser. A first end of the second connection line may be connected to the first line at a downstream end of the electrical component. A second end of the second connection line may be connected to the fourth line at an upstream end of the second chiller.

The at least one mode may include a first mode for cooling the vehicle interior. The at least one mode may include a second mode for cooling the vehicle interior, and for cooling the electrical component and the battery module by using the coolant. The at least one mode may include a third mode for cooling and dehumidifying the vehicle interior, and for cooling the electrical component by using the coolant, and for cooling the battery module by using the coolant heat-exchanged with a refrigerant. The at least one mode may include a fourth mode for heating the vehicle interior, and for recollecting an ambient air heat, a waste heat of the electrical component, and a waste heat of the battery module. The at least one mode may include a fifth mode for heating and dehumidifying the vehicle interior, and for recollecting the waste heat of the battery module. The at least one mode may include a sixth mode for heating and dehumidifying the vehicle interior, and for heating the battery module. In particular, a cooling level in the first mode is higher than a cooling level in the second to sixth modes.

In the first mode, the first line connected to the radiator may be connected, by the valve module, to the first line connected to the electrical component and to the third line connected to the condenser, respectively, so that the coolant cooled in the radiator is introduced into the electrical component and the condenser. The second line may form an independent closed circuit by the valve module, so that the coolant circulates to sequentially pass through the battery module and the first chiller along the second line. A portion of the third line extending from the valve module to the first connection line via the heating core may be closed. The fourth line may form an independent closed circuit by the valve module, so that the coolant circulates to sequentially pass through the cooling core and the second chiller along the fourth line. The first connection line may interconnect the third line and the first line, so that the coolant flowing along the third line from the condenser is introduced into the first line connected to the radiator, and the flow of the coolant flowing through the second connection line may be stopped.

In the second mode, the first line, the second line, and the third line may be interconnected by the valve module, so that the coolant cooled in the radiator is introduced into the electrical component and the battery module. The fourth line may form an independent closed circuit by the valve module, so that the coolant circulates to sequentially pass through the cooling core and the second chiller along the fourth line. The first connection line may interconnect the third line and the first line, so that a partial coolant among the coolant flowing along the third line from the condenser is introduced into the first line connected to the radiator, or a partial coolant among the coolant introduced into the radiator from the electrical component along the first line is introduced into the third line connected to the heating core, and the coolant may stop flowing through the second connection line.

In the third mode, the first line and the third line may be interconnected by the valve module, so that the coolant cooled in the radiator is introduced into the electrical component, the condenser, and the heating core. The second line may form an independent closed circuit by the valve module, so that the coolant circulates to sequentially pass through the battery module and the first chiller along the second line. The fourth line may form an independent closed circuit by the valve module, so that the coolant circulates to sequentially pass through the cooling core and the second chiller along the fourth line. The first connection line may interconnect the third line and the first line, so that a partial coolant among the coolant flowing along the third line from the condenser is introduced into the first line connected to the radiator, or a partial coolant among the coolant introduced into the radiator from the electrical component along the first line is introduced into the third line connected to the heating core. The coolant may stop flowing through the second connection line.

In the fourth mode, the first line connected to the radiator and the fourth line connected to the second chiller may be connected to the first line connected to the electrical component by the valve module, so that the coolant having passed through the radiator and the coolant having passed through the second chiller are introduced into the electrical component. A portion of the fourth line connected from the valve module to the second connection line via the cooling core may be closed. The second line may form an independent closed circuit by the valve module, so that the coolant circulates to sequentially pass through the battery module and the first chiller along the second line. The third line may form an independent closed circuit by the valve module, so that the coolant circulates to sequentially pass through the condenser and the heating core along the third line. The coolant may stop flowing through the first connection line. The second connection line may interconnect the first line and the fourth line so that a partial coolant among the coolant flowing along the first line from the electrical component is introduced into the second chiller.

In the fifth mode, the first line may be closed by the valve module. The second line and the fourth line may be interconnected by the valve module, so that the coolant circulates to sequentially pass through the battery module, the first chiller, the cooling core, and the second chiller. The third line may form an independent closed circuit by the valve module, so that the coolant circulates to sequentially pass through the condenser and the heating core along the third line. The coolant may stop flowing through the first connection line and the second connection line.

In the sixth mode, the first line may be closed by the valve module. The second line and the third line may be interconnected by the valve module, so that the coolant circulates to sequentially pass through the condenser, the heating core, the battery module, and the first chiller. The fourth line may form an independent closed circuit by the valve module, so that the coolant circulates to sequentially pass through the cooling core and the second chiller along the fourth line. The coolant may stop flowing through the first connection line and the second connection line.

The valve module may include a first port to which a first end of the first line is connected, a second port to which a second end of the first line is connected, a third port to which a first end of the second line is connected, a fourth port to which a second end of the second line is connected, a fifth port to which a first end of the third line is connected, a sixth port to which a second end of the third line is connected, a seventh port to which a first end of the fourth line is connected, and an eighth port to which a second end of the fourth line is connected.

The heat pump system may further include a second water pump provided on the second line, a third water pump provided on the third line, and a fourth water pump provided on the fourth line.

In the at least one mode, at least two water pumps provided on the lines interconnected by the valve module, among the first water pump, the second water pump, the third water pump, and the fourth water pump may be operated in different rotation speeds (e.g., revolution per minute (RPM)) for flow control of the coolant.

The first water pump, the second water pump, the third water pump, and the fourth water pump may be pumps having different pumping heads, for flow control of the coolant in the at least one mode.

An electric heater may be further provided on the third line, and the coolant flowing along the third line sequentially passes through the condenser and the electric heater.

An autonomous driving controller may be provided on the second line.

In an embodiment, a heat pump system for a vehicle comprises: a valve module including a plurality of ports through which a coolant is introduced or discharged; a first line having opposite ends connected to the valve module and to which a radiator, an electrical component, and a first water pump are connected; a second line having opposite ends connected to the valve module and to which a battery module and a first chiller are connected; a third line having opposite ends connected to the valve module and to which a heating core and a condenser are connected; a fourth line having opposite ends connected to the valve module and to which a cooling core and a second chiller are connected; a first connection line connecting the first line and the third line; and a second connection line connecting the first line and the fourth line. In particular, the valve module is configured to selectively connect the first to fourth lines and the first and second connection lines based on at least one operation mode for adjusting a temperature of a vehicle interior and a temperature of the battery module.

As described above, according to a heat pump system for a vehicle according to an embodiment of the present disclosure, the thermal energy generated from the refrigerant when condensing and evaporating the refrigerant are selectively heat-exchanged with coolant, and the vehicle interior temperature is adjusted by using the heat-exchanged low-temperature or high-temperature coolant, so that the entire system is streamlined and the layout of connection pipes in which refrigerant circulates is streamlined.

In addition, according to the present disclosure, by selectively using the ambient air heat, the waste heat of the electrical component, or the waste heat of the battery module when heating the vehicle interior, the heating efficiency may be improved, and the overall travel distance of the vehicle may be increased through an efficient adjustment of the temperature of the battery module so that the optimal performance of the battery module may be achieved.

In addition, according to the present disclosure, the temperature of the electrical component and the battery module may be efficiently adjusted through the operation control of the valve module, so that the overall marketability of the vehicle may be improved.

In addition, according to the present disclosure, due to streamlining of the entire system, it is possible to reduce the overall manufacturing cost and weight, and improve space utilization by minimizing the number of components.

### BRIEF DESCRIPTION OF THE DRAWINGS

FIG. 1 is a block diagram of a heat pump system for a vehicle according to an embodiment of the present disclosure.

FIG. 2 is an operation diagram according to a first mode in a heat pump system for a vehicle according to an embodiment of the present disclosure.

FIG. 3 is an operation diagram according to a second mode in a heat pump system for a vehicle according to an embodiment of the present disclosure.

FIG. 4 is an operation diagram according to a third mode in a heat pump system for a vehicle according to an embodiment of the present disclosure.

FIG. 5 is an operation diagram according to a fourth mode in a heat pump system for a vehicle according to an embodiment of the present disclosure.

FIG. 6 is an operation diagram according to a fifth mode in a heat pump system for a vehicle according to an embodiment of the present disclosure.

FIG. 7 is an operation diagram according to a sixth mode in a heat pump system for a vehicle according to an embodiment of the present disclosure.

### DETAILED DESCRIPTION

Embodiments of the present disclosure are hereinafter described in detail with reference to the accompanying drawings.

Embodiments of the present disclosure in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise”, “have”, “include”, and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

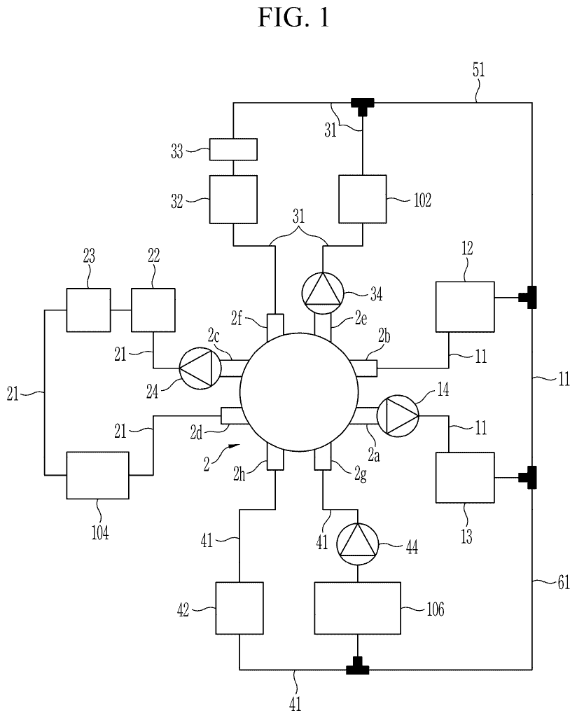

FIG. 1 is a block diagram of a heat pump system for a vehicle according to an embodiment of the present disclosure.

According to a heat pump system for the vehicle according to an embodiment of the present disclosure, the thermal energy generated from the refrigerant when condensing and evaporating a refrigerant may selectively exchange heat with a coolant, and a low-temperature or high-temperature coolant may be used to perform the cooling or heating of a vehicle interior.

In addition, when heating the vehicle interior, the heat pump system may selectively use an ambient air heat, a waste heat of an electrical component 13, and a waste heat of a battery module 22, to improve the heating efficiency of the vehicle, and by efficiently adjusting the temperature of the battery module 22 to achieve the optimal performance of the battery module 22, the overall travel distance of the vehicle may be increased.

Such a heat pump system may be applied to a hybrid vehicle or electric vehicle.

Referring to FIG. 1, the heat pump system may include a valve module 2, a first line 11, a second line 21, a third line 31, a fourth line 41, a first connection line 51, and a second connection line 61.

The valve module 2 may be formed with at least one port through which the coolant is introduced or discharged, and may control the flow of the introduced coolant.

The first line 11 may have a first end and a second end connected to the valve module 2, to allow the coolant to flow therethrough. A radiator 12, the electrical component 13, and a first water pump 14 may be provided on the first line 11.

The radiator 12 may be disposed at the front of the vehicle, and a cooling fan (not pictured) may be provided on a downstream side of the radiator 12. Accordingly, the radiator 12 may cool the coolant through an operation of the cooling fan and exchanging heat with the ambient air.

Accordingly, the coolant cooled in the radiator 12 may be circulated to the valve module 2 along the first line 11.

The electrical component 13 may include an electrical power control unit (EPCU) including a motor, an on-board charger (OBC), or the like.

The electrical power control apparatus may generate heat while driving, and the charger may generate heat when charging the battery module 22 provided in the vehicle.

In other words, when the waste heat of the electrical component 13 is to be recollected at the time of heating the vehicle interior, the heat generated from the electrical power control apparatus may be recollected, and the heat generated from the charger may be recollected when charging the battery module 22.

In an embodiment of the present disclosure, the second line 21 may have a first end and a second end connected to the valve module 2, to allow the coolant to flow therethrough. The battery module 22, a second water pump 24, and a first chiller 104 may be provided on the second line 21.

In addition, an autonomous driving controller 23 may be further provided on the second line 21 between the battery module 22 and the first chiller 104.

The selectively expanded refrigerant may be introduced into the first chiller 104. The first chiller 104 may be operated when the battery module 22 and the autonomous driving controller 23 are to be cooled, or in order to recollect heat from the coolant whose temperature is increased by the waste heat of the battery module 22 at the time of heating of the vehicle interior.

The third line 31 may have a first end and a second end connected to the valve module 2, to allow the coolant to flow therethrough. A heating core 32, a third water pump 34, and a condenser 102 may be provided on the third line 31.

The condenser 102 may be connected to a compressor (not shown) through the refrigerant line. The condenser 102 may condense the refrigerant by exchanging heat with the coolant circulating along the third line 31 with the refrigerant.

In other words, the condenser 102 may condense the introduced refrigerant through exchanging heat with the coolant, and may supply the thermal energy generated when condensing the refrigerant to the coolant to increase a temperature of the coolant.

The condenser 102 configured as such may be a water-cooled heat-exchanger into which the coolant is introduced.

An electric heater 33 may be further provided on the third line 31. The electric heater 33 may be provided on the third line 31 between the heating core 32 and the condenser 102.

Such an electric heater 33 may selectively heat the coolant introduced through the third line 31, to increase the temperature of the coolant.

Accordingly, the third line 31 may connect the condenser 102, the electric heater 33, and the heating core 32 so that the coolant flowing along the third line 31 may sequentially pass through the condenser 102, the electric heater 33, and the heating core 32.

In an embodiment of the present disclosure, the fourth line 41 may have a first end and a second end connected to the valve module 2 to allow the coolant to flow. A cooling core 42, a fourth water pump 44, and a second chiller 106 may be provided on the fourth line 41.

The selectively expanded refrigerant may be introduced into the second chiller 106. When the cooled coolant is to be supplied to the cooling core 42 at the time of cooling the vehicle interior, or when heating of the vehicle interior, the second chiller 106 may be operated to recollect the heat source from the coolant whose temperature is increased by the ambient air heat or the waste heat of the electrical component 13.

In an embodiment of the present disclosure, the first connection line 51 may connect the first line 11 and the third line 31.

A first end of the first connection line 51 may be connected to the first line 11 between the radiator 12 and the electrical component 13. A second end of the first connection line 51 may be connected to the third line 31 at a downstream end of the condenser 102, based on a flow direction of the coolant.

An upstream end of the condenser 102 and the downstream end of the condenser 102 may be set based on the flow direction of the coolant.

In other words, based on the direction in which the coolant flows in the third line 31, the location where the coolant is introduced into the condenser 102 may be defined as an upstream end of the condenser 102, and the location where the coolant is discharged from the condenser 102 may be defined as a downstream end of the condenser 102.

In an embodiment of the present disclosure, the second connection line 61 may connect the first line 11 and the fourth line 41.

A first end of the second connection line 61 may be connected to the first line 11 at a downstream end of the electrical component 13, based on the direction in which the coolant flow. A second end of the second connection line 61 may be connected to the fourth line 41 at an upstream end of the second chiller 106.

The upstream end and the downstream end of the electrical component 13, the upstream end of the second chiller 106 and a downstream end of the second chiller 106 may be set based on the flow direction of the coolant.

In other words, based on the direction in which the coolant flows in the first line 11, the location where the coolant is introduced into the electrical component 13 may be defined as an upstream end of the electrical component 13, and the location where the coolant is discharged from the electrical component 13 may be defined as a downstream end of the electrical component 13.

In addition, based on the direction in which the coolant flows in the fourth line 41, the location where the coolant is introduced into the second chiller 106 may be defined as an upstream end of the second chiller 106, and the location where the coolant is discharged from the second chiller 106 may be defined as a downstream end of the second chiller 106.

In addition, the first water pump 14, the second water pump 24, the third water pump 34, and the fourth water pump 44 may be electric water pumps.

In at least one mode, at least two water pumps provided on the lines interconnected through the valve module 2, among the first water pump 14, the second water pump 24, the third water pump 34, and the fourth water pump 44, may be operated in different rotation speeds (e.g., revolution per minute (RPM)) for flow control of the coolant.

In other words, when the first water pump 14 and the third water pump 34 are configured as pumps of the same pumping head, the first water pump 14 and the third water pump 34 may be operated in different RPMs (i.e., revolution per minute), so that there is a difference between the flow rates of the coolant flowing through the first line 11 and the third line 31.

The pumping head refers to the height a pump can lift when pumping liquid.

For example, when the first line 11 is connected to the third line 31 by the valve module 2, the first water pump 14 and the third water pump 34 may operate in different rotation speeds so that the coolant flows through the first connection line 51.

When the rotation speed of the first water pump 14 operates at a higher rotation speed than the rotation speed of the third water pump 34, a partial coolant among the coolant discharged from the electrical component 13 may be introduced into the radiator 12 along the first line 11.

In addition, a remaining coolant among the coolant discharged from the electrical component 13 may flow along the first connection line 51, and then be introduced into the heating core 32 along the third line 31 connected to the first connection line 51.

In other words, the law of conservation of mass in fluid mechanics can be applied to the coolant, which is an incompressible fluid.

By the first water pump 14 operating at a high rotation speed, the coolant of 15 LPM (liter per minute) may flow from the valve module 2 to the first line 11 connected to the electrical component 13.

In addition, by the third water pump 34 operating at a low rotation speed, the coolant of 10 LPM (liter per minute) may flow from the valve module 2 to the third line 31 connected to the condenser 102.

The coolant of 10 LPM among the coolant of 15 LPM having passed through the electrical component 13 may flow to the valve module 2 through the first line 11 connected to the radiator 12.

In addition, the coolant of 10 LPM introduced into the valve module 2 may flow through the third line 31 connected to the condenser 102 by an operation of the third water pump 34.

The remaining coolant of 5 LPM that does not flow through the first line 11 connected to the radiator 12 may flow along the first connection line 51. Thereafter, the coolant of 5 LPM may join the coolant of 10 LPM having passed through the condenser 102.

Accordingly, the coolant of 15 LPM in total may pass through the heating core 32 along the third line 31, to be introduced into the valve module 2, and then discharged back to the first line 11 connected to the electrical component 13, thereby repeatedly performing the above-described processes.

To the contrary, when the rotation speed of the first water pump 14 operates at a lower rotation speed than the rotation speed of the third water pump 34, a partial coolant among the coolant discharged from the condenser 102 may be introduced into the heating core 32 along the third line 31.

In addition, a remaining coolant among the coolant discharged from the condenser 102 may flow along the first connection line 51, and then be introduced into the radiator 12 along the first line 11 connected to the first connection line 51.

By the first water pump 14 operating at a low rotation speed, the coolant of 10 LPM (liter per minute) may flow from the valve module 2 to the first line 11 connected to the electrical component 13.

In addition, by the third water pump 34 operating at a high rotation speed, the coolant of 15 LPM (liter per minute) may flow from the valve module 2 to the third line 31 connected to the condenser 102.

The coolant of 10 LPM among the coolant of 15 LPM having passed through the condenser 102 may flow to the valve module 2 through the third line 31 connected to the heating core 32.

In addition, the coolant of 10 LPM introduced into the valve module 2 may flow through the first line 11 connected to the electrical component 13 by an operation of the first water pump 14.

The remaining coolant of 5 LPM that does not flow through the third line 31 connected to the heating core 32 may flow along the first connection line 51. Thereafter, the coolant of 5 LPM may join the coolant of 10 LPM having passed through the electrical component 13.

Accordingly, the coolant of 15 LPM in total may pass through the radiator 12 along the first line 11, to be introduced into the valve module 2, and then discharged back to the third line 31 connected to the condenser 102, thereby repeatedly performing the above-described processes.

While the first line 11 is connected to the third line 31 by the valve module 2, when the first water pump 14 and the third water pump 34 operate at the same rotation speed, the flow of the coolant may be stopped in the first connection line 51.

In other words, while the first line 11 and the third line 31 are interconnected by the valve module 2, only when the first water pump 14 and the third water pump 34 are operated in different rotation speeds, the coolant may flow through the first connection line 51, and the flow direction of the coolant may be changed.

As another example, when the first line 11 is connected to the fourth line 41 by the valve module 2, the first water pump 14 and the fourth water pump 44 may operate in different rotation speeds so that the coolant flows through the second connection line 61.

When the rotation speed of the first water pump 14 operates at a higher rotation speed than the rotation speed of the fourth water pump 44, a partial coolant among the coolant discharged from the electrical component 13 may be introduced into the radiator 12 along the first line 11.

In addition, a remaining coolant among the coolant discharged from the electrical component 13 may flow along the second connection line 61, and then be introduced into the second chiller 106 along the fourth line 41 connected to the second connection line 61.

By the first water pump 14 operating at a high rotation speed, the coolant of 15 LPM (liter per minute) may flow from the valve module 2 to the first line 11 connected to the electrical component 13.

In addition, by the fourth water pump 44 operating at a low rotation speed, the coolant of 10 LPM (liter per minute) may flow from the valve module 2 to the fourth line 41 connected to the second chiller 106.

The coolant of 5 LPM among the coolant of 15 LPM having passed through the electrical component 13 may flow to the valve module 2 through the first line 11 connected to the radiator 12.

The remaining coolant of 10 LPM that does not through the first line 11 connected to the radiator 12 may flow along the second connection line 61. Thereafter, the coolant of 10 LPM may flow along the fourth line 41 connected to the second chiller 106.

The coolant of 10 LPM flowing along the fourth line 41 may pass through the second chiller 106, to be introduced into the valve module 2, and pass through the radiator 12, to join the coolant of 5 LPM introduced into the valve module 2.

Accordingly, the coolant of 15 LPM in total may be discharged back to the first line 11 connected to the electrical component 13, thereby repeatedly performing the above-described processes.

When the rotation speed of the first water pump 14 operates at a lower rotation speed than the rotation speed of the fourth water pump 44, a partial coolant among the coolant discharged from the second chiller 106 may be introduced into the electrical component 13 through the first line 11 connected to the electrical component 13 in an inside of the valve module 2.

In addition, a remaining coolant among the coolant discharged from the second chiller 106 may be introduced into the radiator 12 through the first line 11 connected to the radiator 12 inside the interior of the valve module 2.

Accordingly, the coolant having passed through the radiator 12 and the electrical component 13, respectively, may flow along the second connection line 61 connected to the first line 11. Thereafter, the coolant may flow from the second connection line 61 along the fourth line 41 connected to the second chiller 106.

By the first water pump 14 operating at a low rotation speed, the coolant of 10 LPM (liter per minute) may flow from the valve module 2 to the first line 11 connected to the electrical component 13.

In addition, by the fourth water pump 44 operating at a high rotation speed, the coolant of 15 LPM (liter per minute) may flow from the valve module 2 to the fourth line 41 connected to the second chiller 106.

The coolant of 15 LPM having passed through the second chiller 106 may be introduced into the valve module 2 by an operation of the fourth water pump 44.

The coolant of 10 LPM among the coolant of 15 LPM introduced into the valve module 2 may flow the valve module 2 through the first line 11 connected to the electrical component 13 by the operation of the first water pump 14.

In addition, the remaining coolant of 5 LPM among the coolant of 15 LPM introduced into the valve module 2 may flow from the valve module 2 through the first line 11 connected to the radiator 12.

The coolant of 5 LPM having passed through the radiator 12 may join the coolant of 10 LPM having passed through the electrical component 13.

Accordingly, the coolant of 15 LPM in total may flow along the second connection line 61, and then pass through the second chiller 106 along the fourth line 41 connected to the second chiller 106 to be introduced into the valve module 2, thereby repeatedly performing the above-described processes.

While the first line 11 is connected to the fourth line 41 by the valve module 2, when the first water pump 14 and the fourth water pump 44 operate at the same rotation speed, the flow of the coolant connected to the radiator 12 may be stopped in the first line 11.

In other words, while the first line 11 and the fourth line 41 are interconnected by the valve module 2, only when the first water pump 14 and the fourth water pump 44 are operated in different rotation speeds, the coolant connected to the radiator 12 may flow through the first line 11.

An embodiment of the present disclosure takes an example in which the first to fourth water pumps 14, 24, 34, and 44 are configured as pumps of the same pumping head, and the flow of the coolant is controlled by controlling the rotation speeds of respective water pumps, but is not limited thereto.

In other words, the first water pump 14, the second water pump 24, the third water pump 34, and the fourth water pump 44 may be pumps having different pumping heads, respectively.

When the first water pump 14, the second water pump 24, the third water pump 34, and the fourth water pump 44 are pumps of different pumping heads, in the at least one mode, the heat pump system may control the flow of the coolant by only the operation control of the corresponding water pumps, without individually controlling the rotation speeds of respective water pumps.

In an embodiment of the present disclosure, the refrigerant may be selectively introduced into the condenser 102.

Accordingly, the condenser 102 may selectively exchange heat between the thermal energy generated at the time of condensing the refrigerant and the coolant flowing through the third line 31.

Depending on the selected mode of the vehicle, the high-temperature coolant heat-exchanged in the condenser 102 may be introduced into the heating core 32 provided on the third line 31 by a selective operation of the valve module 2 and the third water pump 34.

The condenser 102 may be a water-cooled heat-exchanger into which the coolant is introduced.

In an embodiment of the present disclosure, the first chiller 104 and the second chiller 106 may be connected through respective expansion valves and the refrigerant line, which is not shown in the drawings, and the selectively expanded refrigerant or the unexpanded refrigerant may be introduced thereto.

The first chiller 104 may condense or evaporate the refrigerant by exchanging heat between the coolant circulating along the second line 21 and the refrigerant.

Accordingly, the first chiller 104 may selectively exchange heat between the thermal energy generated at the time of condensing or evaporating the refrigerant with the coolant flowing through the second line 21.

The first chiller 104 may supply the high-temperature thermal energy generated when condensing the refrigerant to the coolant to increase the temperature of the coolant. To the contrary, the first chiller 104 may supply the low-temperature thermal energy generated when evaporating the refrigerant to the coolant to lower the temperature of the coolant.

The first chiller 104 may be a water-cooled heat-exchanger into which the coolant is introduced.

In other words, the high-temperature or low-temperature coolant heat-exchanged in the first chiller 104 may be introduced into the battery module 22 and the autonomous driving controller 23 provided on the second line 21 by the selective operation of the valve module 2 and the second water pump 24 in the selected mode of the vehicle.

Accordingly, the temperature of the battery module 22 and the autonomous driving controller 23 may be adjusted by the introduced high-temperature or low-temperature coolant.

In addition, the second chiller 106 may evaporate the refrigerant by exchanging heat between the coolant circulating along the fourth line 41 with the refrigerant.

In other words, the second chiller 106 may evaporate the introduced refrigerant through exchanging heat with the coolant, and may supply the low-temperature thermal energy generated when evaporating the refrigerant to the coolant to lower the temperature of the coolant. The second chiller 106 may be a water-cooled heat-exchanger into which the coolant is introduced.

Accordingly, when cooling of the vehicle interior is required, or when dehumidification is required at the time of heating of the vehicle interior, the coolant cooled while passing through the second chiller 106 may be introduced into the cooling core 42 along the fourth line 41.

In an embodiment of the present disclosure, the heating core 32 and the cooling core 42 may be provided inside a HVAC module (not shown).

In other words, the ambient air introduced into the vehicle interior may be converted to a high-temperature or low-temperature state by exchanging heat with the high-temperature coolant or the low-temperature coolant introduced into at least one of the heating core 32 or the cooling core 42 by an operation of a blower-fan (not shown).

The high-temperature or low-temperature ambient air may be introduced into the vehicle interior, thereby cooling or heating the vehicle interior.

In an embodiment of the present disclosure, the valve module 2 may be an 8-way valve having eight ports through which the coolant is introduced or discharged. The valve module 2 is described in detail hereinbelow.

The valve module 2 may include a first port 2a, a second port 2b, a third port 2c, a fourth port 2d, a fifth port 2e, a sixth port 2f, a seventh port 2g, and an eighth port 2h.

A first end of the first line 11 may be connected to the first port 2a of the valve module 2. A second end of the first line 11 may be connected to the second port 2b of the valve module 2.

A first end of the second line 21 may be connected to the third port 2c of the valve module 2. A second end of the second line 21 may be connected to the fourth port 2d of the valve module 2.

A first end of the third line 31 may be connected to the fifth port 2e of the valve module 2. A second end of the third line 31 may be connected to the sixth port 2f of the valve module 2.

In addition, a first end of the fourth line 41 may be connected to a seventh port 2g of the valve module 2. A second end of the fourth line 41 may be connected to an eighth port 2h of the valve module 2.

An embodiment of the present disclosure takes an example in which the valve module 2 is a 8-way valve formed with eight ports where the coolant is introduced or discharged, but is not limited thereto, and the valve module 2 may be further provided with ports so that a separate component in which the coolant circulates may be connected.

Depending on at least one mode for adjusting a temperature of a vehicle interior and for adjusting a temperature of the battery module 22, the valve module 2 configured as such may control the flow of the coolant by operating so as to selectively connect the first line 11, the second line 21, the third line 31, the fourth line 41, the first connection line 51, and the second connection line 61, respectively.

The at least one mode may include a first mode to a sixth mode.

In the first mode, the vehicle interior may be maximally cooled. In other words, a cooling level in the first mode is higher than a cooling level in the second to sixth modes.

In a second mode, the vehicle interior may be cooled, and the electrical component 13 and the battery module 22 may be cooled by using the coolant cooled in the radiator 12.

In a third mode, the vehicle interior may be cooled and dehumidified, and the electrical component 13 may be cooled by using the coolant, and the battery module 22 may be cooled by using the coolant heat-exchanged with the refrigerant.

In a fourth mode, the vehicle interior may be heated, and the ambient air heat, the waste heat of the electrical component 13, and the waste heat of the battery module 22 may be recollected.

In a fifth mode, the vehicle interior may be heated-and-dehumidified, and the waste heat of the battery module 22 may be recollected.

In addition, in the sixth mode, the vehicle interior may be heated-and-dehumidified, and the battery module 22 may be heated.

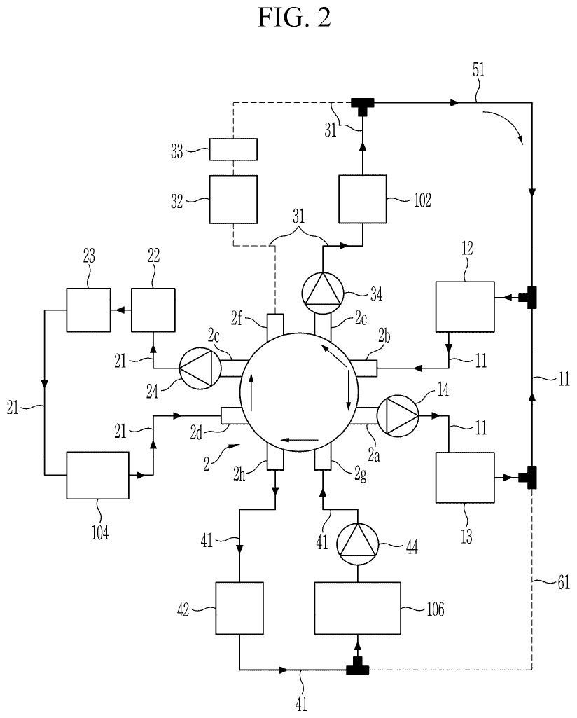

Hereinafter, an operation and action for each mode of a heat pump system for a vehicle according to an embodiment of the present disclosure configured as described above are described in detail with reference to FIG. 2 to FIG. 7.

In a heat pump system for a vehicle according to an embodiment of the present disclosure, operation in the first mode for maximally cooling the vehicle interior is described in detail with reference to FIG. 2.

FIG. 2 is an operation diagram according to the first mode in a heat pump system for the vehicle according to an embodiment of the present disclosure.

Referring to FIG. 2, the first line 11 connected to the radiator 12 may be connected to the first line 11 connected to the electrical component 13 and the third line 31 connected to the condenser 102 by the valve module 2, so that the coolant cooled in the radiator 12 is introduced into the electrical component 13 and the condenser 102.

A portion of the third line 31 connected from the valve module 2 to the first connection line 51 via the heating core 32 may be closed.

The second line 21 may form an independent closed circuit by the valve module 2, so that the coolant circulates to sequentially pass through the battery module 22, the autonomous driving controller 23, and the first chiller 104 along the second line 21.

In addition, the fourth line 41 may form an independent closed circuit by the valve module 2, so that the coolant circulates to sequentially pass through the cooling core 42 and the second chiller 106 along the fourth line 41.

The first connection line 51 may interconnect the third line 31 and the first line 11 so that the coolant flowing along the third line 31 from the condenser 102 is introduced into the first line 11 connected to the radiator 12.

In addition, the flow of the coolant may be stopped in the second connection line 61.

The refrigerant may circulate through the condenser 102, the first chiller 104, and the second chiller 106. The expanded refrigerant may be supplied to the first chiller 104 and the second chiller 106, respectively.

In such a state, the coolant cooled in the radiator 12 may be introduced into the second port 2b of the valve module 2 by the operation of the first water pump 14.

A partial coolant among the coolant introduced into the second port 2b of the valve module 2 may be discharged to the third line 31 connected to the fifth port 2e of the valve module 2 by the operation of the third water pump 34.

The coolant discharged to the third line 31 may pass through the condenser 102, and then flow through the first connection line 51.

The condenser 102 may condense the introduced refrigerant through exchanging heat with the coolant supplied from the radiator 12.

A remaining coolant among the coolant introduced into the first port 2a of the valve module 2 may be discharged through the first port 2a of the valve module 2 by the operation of the first water pump 14, and supplied to the electrical component 13 along the first line 11.

In addition, the coolant having passed through the electrical component 13 may flow along the first line 11.

Accordingly, the coolant flowing along the first connection line 51 and the coolant flowing from the electrical component 13 along the first line 11 may be joined and introduced into the first line 11 connected to the radiator 12.

While repeatedly performing such an operation, the coolant cooled in the radiator 12 may condense the refrigerant supplied to the condenser 102, and efficiently cool the electrical component 13.

The coolant may circulate through the second line 21 by an operation of the second water pump 24.

In other words, the second line 21 may form a second independent closed circuit so that the coolant cooled through exchanging heat with the refrigerant while passing through the first chiller 104 is supplied to the battery module 22 and the autonomous driving controller 23.

In more detail, the coolant introduced into the fourth port 2d of the valve module 2 from the first chiller 104 along the second line 21 may be discharged to the second line 21 connected to the third port 2c of the valve module 2 by the operation of the valve module 2.

The coolant discharged to the second line 21 may sequentially pass through the battery module 22, the autonomous driving controller 23, and the first chiller 104, and then may be introduced into the fourth port 2d of the valve module 2 along the second line 21.

The first chiller 104 may cool the coolant by exchanging heat between the coolant introduced through the second line 21 with the supplied refrigerant.

Therefore, the coolant cooled in the first chiller 104 may efficiently cool the battery module 22 and the autonomous driving controller 23 while circulating along the second line 21.

In addition, the coolant may circulate through the fourth line 41 by the operation of the fourth water pump 44.

In other words, the fourth line 41 may form another independent closed circuit, so that the low-temperature coolant cooled through exchanging heat with the refrigerant while passing through the second chiller 106 may circulate through the cooling core 42.

In more detail, the coolant introduced into the seventh port 2g of the valve module 2 from the second chiller 106 along the fourth line 41 may be discharged to the fourth line 41 connected to the eighth port 2h of the valve module 2 by the operation of the valve module 2.

The coolant discharged to the fourth line 41 may sequentially pass through the cooling core 42 and the second chiller 106, and then may be introduced into the seventh port 2g of the valve module 2 along the fourth line 41.

The second chiller 106 may cool the coolant by exchanging heat between the coolant introduced through the fourth line 41 with the supplied refrigerant, and may evaporate the refrigerant.

Accordingly, the low-temperature coolant cooled in the second chiller 106 may pass through the cooling core 42 while circulating along the fourth line 41.

In other words, the low-temperature coolant cooled in the second chiller 106 may be supplied to the cooling core 42 while circulating along the fourth line 51 through the operation of the fourth water pump 44.

An opening/closing door (not shown) may be provided between the cooling core 42 and the heating core 32. The opening/closing door may close a side toward the heating core 32 so that the ambient air cooled while passing through the cooling core 42 is directly introduced into the vehicle interior.

In such a state, the ambient air introduced into the vehicle interior may be cooled while exchanging heat with the low-temperature coolant supplied to the cooling core 42 by the operation of a blower-fan (not shown). Thereafter, the cooled ambient air may efficiently cool the vehicle interior by being directly introduced into the vehicle interior.

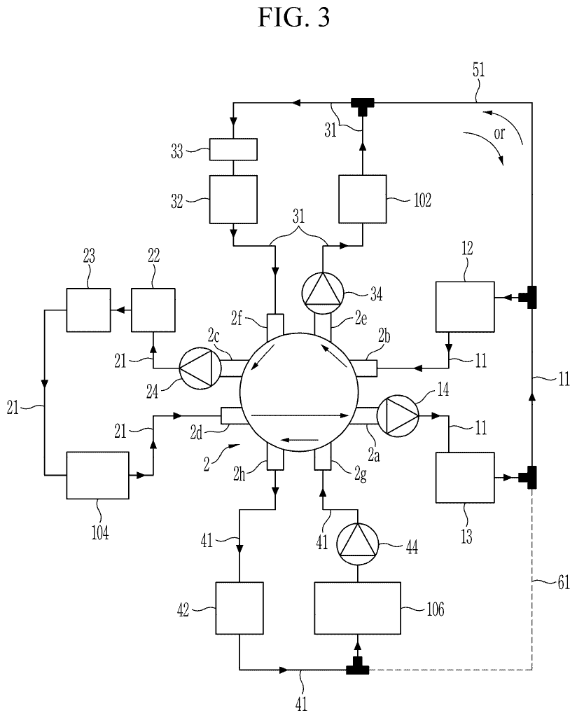

In a heat pump system for a vehicle according to an embodiment of the present disclosure, an operation in the second mode for cooling a vehicle interior, and for cooling the electrical component 13 and the battery module 22 by using the coolant cooled in the radiator 12 is described in detail with reference to FIG. 3.

FIG. 3 is an operation diagram according to the second mode in a heat pump system for a vehicle according to an embodiment of the present disclosure.

Referring to FIG. 3, the first line 11, the second line 21, and the third line 31 may be interconnected by the operation of the valve module 2 so that the coolant cooled in the radiator 12 is introduced into the electrical component 13, the battery module 22, and the condenser 102.

The fourth line 41 may form an independent closed circuit by the valve module 2, so that the coolant circulates to sequentially pass through the cooling core 42 and the second chiller 106 along the fourth line 41.

The first connection line 51 may interconnect the third line 31 and the first line 11 so that a partial coolant among the coolant flowing from the condenser 102 to the third line 31 is introduced into the first line 11 connected to the radiator 12, or a partial coolant among the coolant introduced into the radiator 12 from the electrical component 13 along the first line 11 is introduced into the third line 31 connected to the heating core 32.

In addition, the flow of the coolant may be stopped in the second connection line 61.

The refrigerant may be supplied to the condenser 102 and the second chiller 106, and the refrigerant may not be supplied to the first chiller 104. The expanded refrigerant may be supplied to the second chiller 106.

In such a state, the coolant cooled in the radiator 12 may be introduced into the second port 2b of the valve module 2 along the first line 11 by the first water pump 14, the second water pump 24, and by the operation of the third water pump 34.

The coolant introduced into the second port 2b of the valve module 2 may be discharged to the third line 31 connected to the fifth port 2e of the valve module 2 by the operation of the valve module 2.

The coolant discharged to the third line 31 may pass through the condenser 102.

The condenser 102 may condense the introduced refrigerant through exchanging heat with the coolant supplied from the radiator 12.

An entire or partial coolant among the coolant having passed through the condenser 102 may pass through the heating core 32 along the third line 31, to be introduced into a sixth port 2f of the valve module 2.

When the rotation speed of the first water pump 14 operates at a higher rotation speed than the rotation speed of the third water pump 34, the coolant having passed through the condenser 102 may be introduced into the third line 31 connected to the heating core 32 together with the coolant flowing along the first connection line 51.

When the rotation speed of the first water pump 14 operates at a lower rotation speed than the rotation speed of the third water pump 34, a partial coolant among the coolant having passed through the condenser 102 may be introduced into the first line 11 on which the radiator 12 is provided along the first connection line 51.

In addition, a remaining coolant among the coolant having passed through the condenser 102 may be introduced into the third line 31 connected to the heating core 32.

The coolant having passed through the heating core 32 may be introduced into the sixth port 2f of the valve module 2 along the third line 31.

The coolant introduced into the sixth port 2f of the valve module 2 may be discharged to the second line 21 connected to the third port 2c of the valve module 2 by the operation of the valve module 2.

The coolant discharged to the second line 21 may sequentially pass through the battery module 22, the autonomous driving controller 23, and the first chiller 104. Thereafter, the coolant may be introduced into the fourth port 2d of the valve module 2 along the second line 21.

The coolant introduced into the fourth port 2d of the valve module 2 may be discharged to the first line 11 connected to the first port 2a of the valve module 2 by the operation of the valve module 2.

The coolant discharged to the first line 11 may pass through the electrical component 13 along the first line 11. Thereafter, an entire or partial coolant among the coolant having passed through the electrical component 13 may pass through the radiator 12 along the first line 11, to be introduced into the second port 2b of the valve module 2.

When the rotation speed of the first water pump 14 operates at a higher rotation speed than the rotation speed of the third water pump 34, a partial coolant among the coolant having passed through the electrical component 13 may be introduced into the first line 11 connected to the radiator 12.

In addition, a remaining coolant among the coolant having passed through the electrical component 13 may flow through the first connection line 51, and pass through the condenser 102 to be introduced into the third line 31 connected to the heating core 32 together with the coolant flowing through the third line 31.

When the rotation speed of the first water pump 14 operates at a lower rotation speed than the rotation speed of the third water pump 34, the coolant having passed through the electrical component 13 may be introduced into the first line 11 connected to the radiator 12 together with the coolant introduced through the first connection line 51 from the third line 31.

Through the above-described operation, the coolant may flow through the first connection line 51 from the first line 11 toward the third line 31, or may flow from the third line 31 toward the first line 11.

In other words, the heat pump system may control the flow direction of the coolant flowing through the first connection line 51, by operating the first water pump 14 and the third water pump 34 in different rotation speeds.

As such, in the second mode, the first line 11, the second line 21, and the third line 31 may form one closed circuit in which the coolant circulates by the operation of the valve module 2.

In such a state, the coolant may circulate along the first line 11, the second line 21, and the third line 31 interconnected by the operation of the first water pump 14, the second water pump 24, and the third water pump 34.

In other words, the coolant cooled in the radiator 12 may circulate along the first line 11, the second line 21, and the third line 31 while repeatedly performing the above-described operation.

Accordingly, the electrical component 13, the battery module 22, and the autonomous driving controller 23 may be efficiently cooled by the coolant cooled in the radiator 12.

In addition, the coolant may circulate through the fourth line 41 by the operation of the fourth water pump 44.

In other words, the fourth line 41 may form a second independent closed circuit, so that the low-temperature coolant cooled through exchanging heat with the refrigerant while passing through the second chiller 106 may circulate through the cooling core 42.

The coolant introduced into the seventh port 2g of the valve module 2 from the second chiller 106 along the fourth line 41 may be discharged to the fourth line 41 connected to the eighth port 2h of the valve module 2 by the operation of the valve module 2.

The coolant discharged to the fourth line 41 may sequentially pass through the cooling core 42 and the second chiller 106, and then may be introduced into the seventh port 2g of the valve module 2 along the fourth line 41.

The second chiller 106 may cool the coolant by exchanging heat between the coolant introduced through the fourth line 41 and the supplied refrigerant, and may evaporate the refrigerant.

Accordingly, the low-temperature coolant cooled in the second chiller 106 may pass through the cooling core 42 while circulating along the fourth line 41.

In other words, the low-temperature coolant cooled in the second chiller 106 may be supplied to the cooling core 42 while circulating along the fourth line 41 through the operation of the fourth water pump 44.

In addition, since the fourth line 41 forms an independent closed circuit, the coolant may not flow through the second connection line 61.

The opening/closing door (not shown) may be provided between the cooling core 42 and the heating core 32. The opening/closing door may close a side toward the heating core 32 so that the ambient air cooled while passing through the cooling core 42 is directly introduced into the vehicle interior.

In such a state, the ambient air introduced into the vehicle interior may be cooled while exchanging heat with the low-temperature coolant supplied to the cooling core 42 by the operation of a blower-fan (not shown). Thereafter, the cooled ambient air may efficiently cool the vehicle interior by being directly introduced into the vehicle interior.

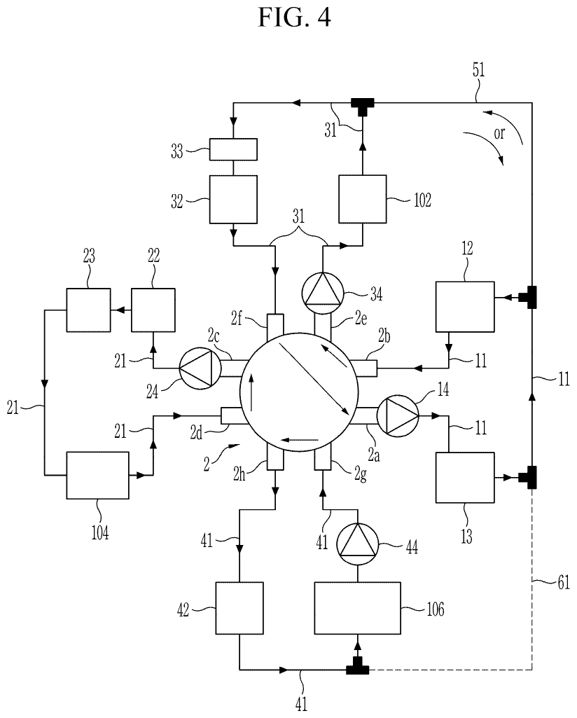

In a heat pump system for the vehicle according to an embodiment of the present disclosure, an operation in the third mode for cooling-and-dehumidifying the vehicle interior, and for cooling the electrical component 13 by using the coolant, and for cooling the battery module 22 by using the coolant heat-exchanged with the refrigerant is described in detail with reference to FIG. 4.

FIG. 4 is an operation diagram according to the third mode in a heat pump system for the vehicle according to an embodiment of the present disclosure.

Referring to FIG. 4, the refrigerant may circulate through the condenser 102, the first chiller 104, and the second chiller 106. The expanded refrigerant may be supplied to the first chiller 104 and the second chiller 106, respectively.

In addition, the first line 11 may connected to the third line 31 by the operation of the valve module 2, so that the coolant cooled in the radiator 12 is introduced into the electrical component 13, the condenser 102, and the heating core 32.

The second line 21 may form an independent closed circuit by the valve module 2, so that the coolant circulates to sequentially pass through the battery module 22, the autonomous driving controller 23, and the first chiller 104 along the second line 21.

In addition, the fourth line 41 may form an independent closed circuit by the valve module 2, so that the coolant circulates to sequentially pass through the cooling core 42 and the second chiller 106 along the fourth line 41.

The first connection line 51 may interconnect the third line 31 and the first line 11 so that the coolant flowing along the third line 31 from the condenser 102 is introduced into the first line 11 connected to the radiator 12.

In addition, the flow of the coolant may be stopped in the second connection line 61.

In such a state, the coolant cooled in the radiator 12 may be introduced into the second port 2b of the valve module 2 by the operation of the first water pump 14.

The coolant introduced into the second port 2b of the valve module 2 may be discharged to the third line 31 connected to the fifth port 2e of the valve module 2 by the operation of the third water pump 34.

The coolant discharged to the third line 31 may pass through the condenser 102.

The condenser 102 may condense the introduced refrigerant through exchanging heat with the coolant supplied from the radiator 12.

Thereafter, an entire or partial coolant among the coolant having passed through the condenser 102 may pass through the heating core 32 along the third line 31, to be introduced into the sixth port 2f of the valve module 2.

When the rotation speed of the first water pump 14 operates at a higher rotation speed than the rotation speed of the third water pump 34, the coolant having passed through the condenser 102 may be introduced into the third line 31 connected to the heating core 32 together with the coolant flowing along the first connection line 51.

When the rotation speed of the first water pump 14 operates at a lower rotation speed than the rotation speed of the third water pump 34, a partial coolant among the coolant having passed through the condenser 102 may be introduced into the first line 11 on which the radiator 12 is provided along the first connection line 51.

In addition, a remaining coolant among the coolant having passed through the condenser 102 may be introduced into the third line 31 connected to the heating core 32.

The coolant having passed through the heating core 32 may be introduced into the sixth port 2f of the valve module 2 along the third line 31.

The coolant introduced into the sixth port 2f of the valve module 2 may be discharged to the first line 11 connected to the first port 2a of the valve module 2 by the operation of the valve module 2.

The coolant discharged to the first line 11 may pass through the electrical component 13 along the first line 11. Thereafter, an entire or partial coolant among the coolant having passed through the electrical component 13 may pass through the radiator 12 along the first line 11, to be introduced into the second port 2b of the valve module 2.

When the rotation speed of the first water pump 14 operates at a higher rotation speed than the rotation speed of the third water pump 34, a partial coolant among the coolant having passed through the electrical component 13 may be introduced into the first line 11 connected to the radiator 12.

In addition, a remaining coolant among the coolant having passed through the electrical component 13 may flow through the first connection line 51, and pass through the condenser 102 to be introduced into the third line 31 connected to the heating core 32 together with the coolant flowing through the third line 31.

When the rotation speed of the first water pump 14 operates at a lower rotation speed than the rotation speed of the third water pump 34, the coolant having passed through the electrical component 13 may be introduced into the first line 11 connected to the radiator 12 together with the coolant introduced through the first connection line 51 from the third line 31.

While repeatedly performing such an operation, the coolant cooled in the radiator 12 may condense the refrigerant supplied to the condenser 102.

The coolant passing through the condenser 102 may increase its temperature while exchanging heat with the refrigerant. The coolant whose temperature is increased may be cooled again through exchanging heat with the ambient air while passing through the heating core 32. The cooled coolant may efficiently cool the electrical component 13.

Through the above-described operation, the coolant may flow through the first connection line 51 from the first line 11 toward the third line 31, or may flow from the third line 31 toward the first line 11.

In other words, the heat pump system may control the flow direction of the coolant flowing through the first connection line 51, by operating the first water pump 14 and the third water pump 34 in different rotation speeds.

The coolant may circulate through the second line 21 by the operation of the second water pump 24.

In other words, the second line 21 may form a second independent closed circuit so that the coolant cooled through exchanging heat with the refrigerant while passing through the first chiller 104 is supplied to the battery module 22 and the autonomous driving controller 23.

The coolant introduced into the fourth port 2d of the valve module 2 from the first chiller 104 along the second line 21 may be discharged to the second line 21 connected to the third port 2c of the valve module 2 by the operation of the valve module 2.

The coolant discharged to the second line 21 may sequentially pass through the battery module 22, the autonomous driving controller 23, and the first chiller 104, and then may be introduced into the fourth port 2d of the valve module 2 along the second line 21.

The first chiller 104 may cool the coolant by exchanging heat between the coolant introduced through the second line 21 and the supplied refrigerant.

Therefore, the coolant cooled in the first chiller 104 may efficiently cool the battery module 22 and the autonomous driving controller 23 while circulating along the second line 21.

In addition, the coolant may circulate through the fourth line 41 by the operation of the fourth water pump 44.

In other words, the fourth line 41 may form another independent closed circuit, so that the low-temperature coolant cooled through exchanging heat with the refrigerant while passing through the second chiller 106 may circulate the cooling core 42.

The coolant introduced into the seventh port 2g of the valve module 2 from the second chiller 106 along the fourth line 41 may be discharged to the fourth line 21 connected to the eighth port 2h of the valve module 2 by the operation of the valve module 2.

The coolant discharged to the fourth line 41 may sequentially pass through the cooling core 42 and the second chiller 106, and then may be introduced into the seventh port 2g of the valve module 2 along the fourth line 41.

The second chiller 106 may cool the coolant by exchanging heat between the coolant introduced through the fourth line 41 and the supplied refrigerant, and may evaporate the refrigerant.

Accordingly, the low-temperature coolant cooled in the second chiller 106 may pass through the cooling core 42 while circulating along the fourth line 41.

In other words, the low-temperature coolant cooled in the second chiller 106 may be supplied to the cooling core 42 while circulating along the fourth line 41 through the operation of the fourth water pump 44.

The opening/closing door (not shown) provided between the cooling core 42 and the heating core 32 may open a portion for passing through the heating core 32, so that the ambient air cooled while passing through the cooling core 42 may pass through the heating core 32.

Accordingly, the ambient air introduced into the vehicle interior may be cooled while exchanging heat with the low-temperature coolant supplied to the cooling core 42 by the operation of a blower-fan (not shown). Thereafter, the cooled ambient air may be dehumidified while passing through the heating core 32 and then introduced into the vehicle interior, thereby smoothly cooling and dehumidifying the vehicle interior.

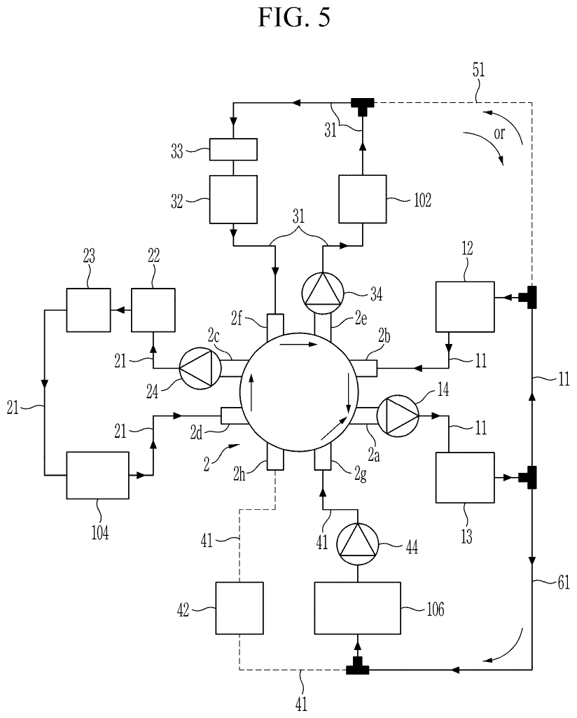

In a heat pump system for the vehicle according to an embodiment of the present disclosure, an operation in the fourth mode for heating a vehicle interior, and for recollecting the ambient air heat, the waste heat of the electrical component 13, and the waste heat of the battery module 22 is described in detail with reference to FIG. 5.

FIG. 5 is an operation diagram according to the fourth mode in a heat pump system for a vehicle according to an embodiment of the present disclosure.

Referring to FIG. 5, the first line 11 connected to the radiator 12, and the fourth line 41 connected to the second chiller 106 may be respectively connected to the first line 11 connected to the electrical component 13 by the valve module 2, so that the coolant having passed through the radiator 12 and the coolant having passed through the second chiller 106 are introduced into the electrical component 13.

A portion of the fourth line 41 connected from the valve module 2 to the second connection line 61 via the cooling core 42 may be closed.

The second line 21 may form an independent closed circuit by the valve module 2, so that the coolant circulates to sequentially pass through the battery module 22, the autonomous driving controller 23, and the first chiller 104 along the second line 21.

In addition, the third line 31 may form an independent closed circuit by the valve module 2, so that the coolant circulates to sequentially pass through the condenser 102 and the heating core 32 along the third line 31.

The flow of the coolant may be stopped in the first connection line 51.

In addition, the second connection line 61 may interconnect the first line 11 and the fourth line 41 so that a partial coolant among the coolant flowing along the first line 11 from the electrical component 13 is introduced into the second chiller 106.

The refrigerant may circulate through the condenser 102, the first chiller 104, and the second chiller 106. The expanded refrigerant may be supplied to the first chiller 104 and the second chiller 106, respectively.

In such a state, the coolant having passed through the second chiller 106 may be introduced into the seventh port 2g of the valve module 2 by the operation of the fourth water pump 44.

An entire or partial coolant among the coolant introduced into the seventh port 2g of the valve module 2 may be discharged through the first port 2a of the valve module 2 by the operation of the first water pump 14.

When the rotation speed of the first water pump 14 operates at a higher rotation speed than the rotation speed of the fourth water pump 44, the coolant introduced into the seventh port 2g of the valve module 2 may be discharged to the first line 11 connected to the first port 2a to be entirely supplied to the electrical component 13.

A partial coolant among the coolant discharged from the electrical component 13 may be introduced into the radiator 12 along the first line 11. Thereafter, the coolant having passed through the radiator 12 may be introduced into the second port 2b of the valve module 2.

In addition, a remaining coolant among the coolant discharged from the electrical component 13 may flow along the second connection line 61, and then be introduced into the second chiller 106 along the fourth line 41 connected to the second connection line 61.

When the rotation speed of the first water pump 14 operates at a lower rotation speed than the rotation speed of the fourth water pump 44, a partial coolant among the coolant introduced into the seventh port 2g of the valve module 2 may be discharged to the first line 11 connected to the first port 2a to pass through the electrical component 13.

In addition, a remaining coolant among the coolant introduced into the seventh port 2g of the valve module 2 may be discharged to the first line 11 connected to the second port 2b to pass through the radiator 12.

The coolant having passed through the radiator 12 and the coolant having passed through the electrical component 13 may flow along the second connection line 61 connected to the first line 11.

The coolant may be introduced into the second chiller 106 along the fourth line 41 connected to the second connection line 61.

Through the above-described operation, the coolant introduced from the second chiller 106 into the valve module 2 may be entirely discharged through the first port 2a and the second port 2b, or may be discharged through the first port 2a together with the coolant introduced through the second port 2b.

Accordingly, through the first line 11 connecting the radiator 12 and the electrical component 13, the coolant may flow from the radiator 12 toward the electrical component 13, or may flow from the electrical component 13 toward the radiator 12.

In other words, the heat pump system may control the flow direction of the coolant flowing through the first line 11 connecting the radiator 12 and the electrical component 13, by operating the first water pump 14 and the fourth water pump 44 in different rotation speeds.

Accordingly, the coolant may recollect the ambient air heat through exchanging heat with the ambient air while passing through the radiator 12, and may increase its temperature by absorbing the waste heat from the electrical component 13.

The coolant whose temperature is increased may pass through the second chiller 106 sequentially along the first line 11, the second connection line 61, and the fourth line 41 by the operation of the first water pump 14 and the fourth water pump 44.

Therefore, the ambient air heat recollected in the radiator 12 and the waste heat generated from the electrical component 13 may increase the temperature of the refrigerant supplied to the second chiller 106.

In other words, the second chiller 106 may recollect the ambient air heat and the waste heat of the electrical component 13 through exchanging heat between the coolant and the refrigerant, and use it to increase the temperature of the refrigerant.

The coolant having passed through the second chiller 106 may be introduced into the seventh port 2g of the valve module 2 along the fourth line 41.

The coolant introduced into the seventh port 2g of the valve module 2 may be entirely discharged through the first port 2a and the second port 2b by the operation of the valve module 2, or may be discharged through the first port 2a together with the coolant introduced through the second port 2b.

In addition, the coolant may pass through the radiator 12 and the electrical component 13 respectively, and then may be introduced back into the valve module 2, thereby repeatedly performing the above-described processes.

The coolant may circulate through the second line 21 by the operation of the second water pump 24.

In other words, the coolant may be discharged to the second line 21 connected to the third port 2c by the operation of the valve module 2 and the second water pump 24.

The coolant discharged to the second line 21 may pass through the battery module 22 and the autonomous driving controller 23, to be introduced into the fourth port 2d of the valve module 2 along the second line 21.

The coolant may increase its temperature by absorbing the waste heat from the battery module 22 while passing through the battery module 22 and the autonomous driving controller 23.

The coolant whose temperature is increased may be supplied to the first chiller 104 along the second line 21. Therefore, the waste heat generated from the battery module 22 may increase the temperature of the refrigerant supplied to the first chiller 104.

In other words, the first chiller 104 may recollect the waste heat of the battery module 22 through exchanging heat between the coolant and the refrigerant, and use it to increase the temperature of the refrigerant.

The coolant having passed through the first chiller 104 may be introduced into the fourth port 2d of the valve module 2 along the second line 21, thereby repeatedly performing the above-described processes.

In addition, the coolant may circulate through the third line 31 by the operation of the third water pump 34.

In other words, the third line 31 may form another independent closed circuit, so that the high-temperature coolant whose temperature is increased through exchanging heat with the refrigerant while passing through the condenser 102 may circulate the heating core 32.

The coolant introduced into the sixth port 2f of the valve module 2 through the third line 31 may be discharged to a fifth port 2e of the valve module 2 by the operation of the third water pump 34 and the valve module 2.

The coolant circulating along the third line 31 may sequentially pass through the condenser 102 and the electric heater 33. The condenser 102 may condense the refrigerant by using the coolant flowing along the third line 31.

The coolant may increase its temperature while condensing the refrigerant in the condenser 102. The coolant whose temperature is increased while passing through the condenser 102 may be introduced into the heating core 32 along the third line 31.

In such a state, the ambient air introduced into the vehicle interior may be converted into a high-temperature state while exchanging heat with the high-temperature coolant supplied to the heating core 32 by the operation of a blower-fan (not shown).

The high-temperature ambient air may be introduced into the vehicle interior, thereby achieving heating of the vehicle interior.

In other words, in a heat pump system according to an embodiment of the present disclosure, at the time of heating the vehicle interior, the ambient air heat, the waste heat of the electrical component 13, and the waste heat of the battery module 22 may be absorbed by the first and second chillers 104 and 106 and may be used to increase the temperature of the refrigerant, thereby reducing the power consumption of the compressor, and improving the heating efficiency.

The coolant having passed through the heating core 32 may flow along the third line 31, and introduced into the sixth port 2f of the valve module 2, thereby repeatedly performing the above-described processes.

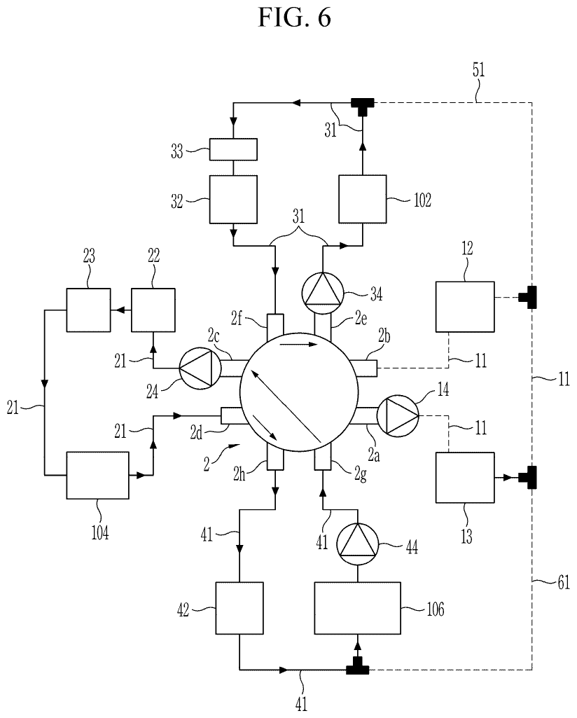

In a heat pump system for the vehicle according to an embodiment of the present disclosure, an operation in the fifth mode for heating and dehumidifying the vehicle interior, and for recollecting the waste heat of the battery module 22 is described in detail with reference to FIG. 6.

FIG. 6 is an operation diagram according to the fifth mode in a heat pump system for a vehicle according to an embodiment of the present disclosure.

Referring to FIG. 6, the first line 11 may be closed by the valve module 2.

In addition, the second line 21 and the fourth line 41 may be interconnected by the valve module 2, so that the coolant circulates to sequentially pass through the battery module 22, the autonomous driving controller 23, the first chiller 104, the cooling core 42, and the second chiller 106.

The third line 31 may form an independent closed circuit by the valve module 2, so that the coolant circulates to sequentially pass through the condenser 102 and the heating core 32 along the third line 31.

The flow of the coolant may be stopped in the first connection line 51 and the second connection line 61.

The refrigerant may circulate through the condenser 102, the first chiller 104, and the second chiller 106. The expanded refrigerant may be supplied to the first chiller 104 and the second chiller 106, respectively.

In such a state, the coolant having passed through the second chiller 106 may be introduced into the seventh port 2g of the valve module 2 by the operation of the fourth water pump 44.

The coolant introduced into the seventh port 2g of the valve module 2 may be discharged through the third port 2c of the valve module 2 by the operation of the second water pump 24.

The coolant discharged through the third port 2c may sequentially pass through the battery module 22, the autonomous driving controller 23, and the first chiller 104 along the second line 21.

The coolant may increase its temperature by absorbing the waste heat from the battery module 22 while passing through the battery module 22 and the autonomous driving controller 23.

The coolant whose temperature is increased may be supplied to the first chiller 104 along the second line 21. Therefore, the waste heat generated from the battery module 22 may increase the temperature of the refrigerant supplied to the first chiller 104.

In other words, the first chiller 104 may recollect the waste heat of the battery module 22 through exchanging heat between the coolant and the refrigerant, and use it to increase the temperature of the refrigerant.

In addition, the first chiller 104 may cool the coolant circulating along the second line 21 through exchanging heat with a low-temperature refrigerant, and may evaporate the refrigerant. In addition, the low-temperature coolant cooled while passing through the first chiller 104 may be introduced into the fourth port 2d of the valve module 2 along the second line 21.

The coolant introduced into the fourth port 2d of the valve module 2 may be discharged through an eighth port 2h of the valve module 2.

The coolant discharged through the eighth port 2h of the valve module 2 may sequentially pass through the cooling core 42 and the second chiller 106 along the fourth line 41.

Accordingly, the low-temperature coolant cooled in the first chiller 104 may be supplied to the cooling core 42 and the second chiller 106 while circulating along the second line 21 and the fourth line 41 through the operation of the second water pump 24 and the fourth water pump 44.

The coolant having passed through the second chiller 106 may be introduced into the seventh port 2g of the valve module 2 along the fourth line 41, and repeatedly perform the above-described processes.

In addition, the coolant may circulate through the third line 31 by the operation of the third water pump 34.

In other words, the third line 31 may form another independent closed circuit, so that the high-temperature coolant whose temperature is increased through exchanging heat with the refrigerant while passing through the condenser 102 may circulate the heating core 32.

The coolant introduced into the sixth port 2f of the valve module 2 through the third line 31 may be discharged through the fifth port 2e of the valve module 2 by the operation of the third water pump 34 and the valve module 2.

The coolant circulating along the third line 31 may sequentially pass through the condenser 102 and the electric heater 103. The condenser 102 may condense the refrigerant by using the coolant flowing along the third line 31.

The coolant may increase its temperature while condensing the refrigerant in the condenser 102. The coolant whose temperature is increased while passing through the condenser 102 may be introduced into the heating core 32 along the third line 31.

In such a state, the opening/closing door (not shown) provided between the cooling core 42 and the heating core 32 may open a portion for passing through the heating core 32, so that the ambient air cooled while passing through the cooling core 42 may pass through the heating core 32.

Accordingly, the ambient air introduced into the vehicle interior may be dehumidified while exchanging heat with the low-temperature coolant supplied to the cooling core 42 by the operation of a blower-fan (not shown).

The dehumidified ambient air may be converted into a high-temperature state while passing through the heating core 32 and introduced into the vehicle interior, thereby smoothly heating and dehumidifying the vehicle interior.

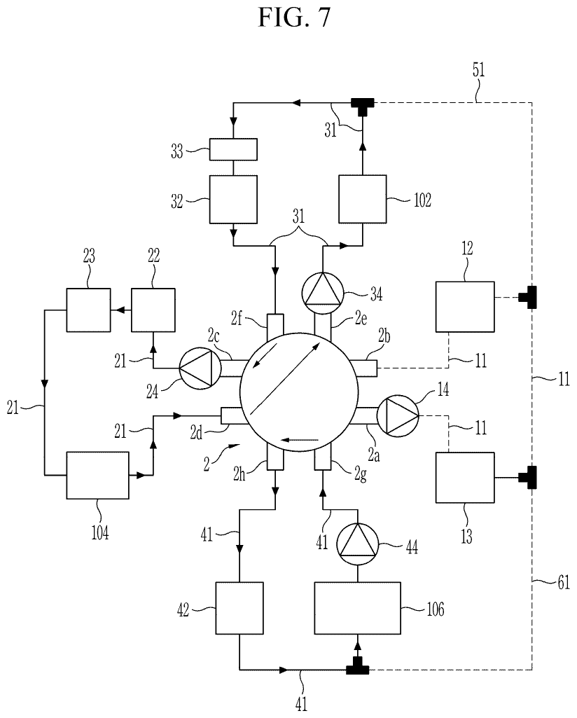

In addition, in a heat pump system for a vehicle according to an embodiment of the present disclosure, an operation in the sixth mode for heating and dehumidifying the vehicle interior, and for heating the battery module 22 is described in detail with reference to FIG. 7.

FIG. 7 is an operation diagram according to the fifth mode in a heat pump system for a vehicle according to an embodiment of the present disclosure.

Referring to FIG. 7, the first line 11 may be closed by the valve module 2.

In addition, the second line 21 and the third line 31 may be interconnected by the valve module 2, so that the coolant circulates to sequentially pass through the condenser 102, the heating core 32, the battery module 22, and the first chiller 104.

In other words, the second line 21 may be connected to the third line 31 by the operation of the valve module 2, so that the coolant whose temperature is increased while passing through the condenser 102 is introduced into the battery module 22.

The fourth line 41 may form an independent closed circuit by the valve module 2, so that the coolant circulates to sequentially pass through the cooling core 42 and the second chiller 106 along the fourth line 41.

The flow of the coolant may be stopped in the first connection line 51 and the second connection line 61.

The refrigerant may circulate through the condenser 102, the first chiller 104, and the second chiller 106. The expanded refrigerant may be supplied to the first chiller 104 and the second chiller 106, respectively.

In such a state, the coolant may be discharged to the second line 21 connected to the third port 2c of the valve module 2 by the operation of the second water pump 24.

The coolant discharged to the second line 21 may sequentially pass through the battery module 22, the autonomous driving controller 23, and the first chiller 104.

The coolant may be introduced into the fourth port 2d of the valve module 2 along the second line.

The coolant introduced into the fourth port 2d of the valve module 2 may be discharged to the third line 31 connected to the fifth port 2e of the valve module 2 by the operation of the valve module 2 and the third water pump 34.

The coolant discharged to the third line 31 may sequentially pass through the condenser 102, the electric heater 33, and the heating core 32. The condenser 102 may condense the refrigerant by using the coolant flowing along the third line 31.

The coolant may increase its temperature while condensing the refrigerant in the condenser 102. The coolant whose temperature is increased while passing through the condenser 102 may be introduced into the heating core 32 along the third line 31.

The coolant having passed through the heating core 32 may flow along the third line 31, and may be introduced into the sixth port 2f of the valve module 2.

The coolant introduced into the sixth port 2f of the valve module 2 may be discharged to the second line 21 connected to the third port 2c of the valve module 2 by the operation of the second water pump 24 and the valve module 2.

The coolant discharged to the second line 21 may increase the temperature of the battery module 22 while passing through the battery module 22.

In other words, through such an operation, the battery module 22 may efficiently increase its temperature as the coolant whose temperature is increased is supplied.

As such, in the sixth mode, the second line 21 and the third line 31 may form a closed circuit in which the coolant circulates by the operation of the valve module 2.

In such a state, the coolant may circulate along the second line 21 and the third line 31 interconnected by the operation of the second water pump 24 and the third water pump 32.

In other words, when heating of the battery module 22 is required, the heat pump system may efficiently increase the temperature of the battery module 22 by supplying the coolant whose temperature is increased while passing through the condenser 102 to the battery module 22.

The coolant may circulate through the fourth line 41 by the operation of the fourth water pump 44.

In other words, the fourth line 41 may form another independent closed circuit, so that the low-temperature coolant cooled through exchanging heat with the refrigerant while passing through the second chiller 106 may circulate through the cooling core 42.

The coolant introduced into the seventh port 2g of the valve module 2 from the second chiller 106 along the fourth line 41 may be discharged to the fourth line 41 connected to the eighth port 2h of the valve module 2 by the operation of the valve module 2.

The coolant discharged to the fourth line 41 may sequentially pass through the cooling core 42 and the second chiller 106, and then may be introduced into the seventh port 2g of the valve module 2 along the fourth line 41.

The second chiller 106 may cool the coolant by exchanging heat between the coolant introduced through the fourth line 41 with the supplied refrigerant, and may evaporate the refrigerant.

Accordingly, the low-temperature coolant cooled in the second chiller 106 may pass through the cooling core 42 while circulating along the fourth line 41.

In other words, the low-temperature coolant cooled in the second chiller 106 may be supplied to the cooling core 42 while circulating along the fourth line 41 through the operation of the fourth water pump 44.

In such a state, the opening/closing door (not shown) provided between the cooling core 42 and the heating core 32 may open a portion for passing through the heating core 32, so that the ambient air cooled while passing through the cooling core 42 may pass through the heating core 32.

Accordingly, the ambient air introduced into the vehicle interior may be dehumidified while exchanging heat with the low-temperature coolant supplied to the cooling core 42 by the operation of a blower-fan (not shown).

The dehumidified ambient air may be converted into a high-temperature state while passing through the heating core 32 and introduced into the vehicle interior, thereby smoothly heating and dehumidifying the vehicle interior.

As described above, according to a heat pump system for a vehicle according to an embodiment of the present disclosure, by selectively exchanging heat between the thermal energy generated from the refrigerant at the time of condensing and evaporating the refrigerant with the coolant and adjusting the vehicle interior temperature by using the heat-exchanged low-temperature or high-temperature coolant, the entire system may be streamlined and the layout of connection pipes in which refrigerant circulates may be streamlined.

In addition, according to the present disclosure, at the time of heating of the vehicle interior, by selectively using the ambient air heat, the waste heat of the electrical component 13, and the waste heat of the battery module 22, the heating efficiency of the vehicle may be improved, and the overall travel distance of the vehicle may be increased through efficient temperature adjustment of the battery module 22, so that the optimal performance of the battery module 22 can be achieved.

In addition, according to the present disclosure, the temperature of the electrical component 13 and the battery module 22 can be efficiently adjusted by controlling the valve module 2, thereby improving the overall marketability of the vehicle.

In addition, according to the present disclosure, due to streamlining of the entire system, it is possible to reduce the overall manufacturing cost and weight, and improve space utilization by minimizing the number of components.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2: valve module
11: first line
12: radiator
13: electrical component
14: first water pump
21: second line
22: battery module
23: autonomous driving controller
24: second water pump
31: third line
32: heating core
33: electric heater
34: third water pump
41: fourth line
42: cooling core
44: fourth water pump
102: condenser
104: first chiller
106: second chiller

What is claimed is:

1. A heat pump system for a vehicle, the heat pump system comprising:
a valve module including at least one port through which coolant is introduced or discharged;
a first line configured to allow coolant to flow and including a first end and a second end connected to the valve module, wherein a radiator, an electrical component, and a first water pump are connected to the first line;
a second line configured to allow the coolant to flow and including a first end and a second end connected to the valve module, wherein a battery module and a first chiller are connected to the second line;
a third line configured to allow the coolant to flow and including a first end and a second end connected to the valve module, wherein a heating core and a condenser are connected to the third line;
a fourth line configured to allow the coolant to flow and including a first end and a second end connected to the valve module, wherein a cooling core and a second chiller are connected to the fourth line;
a first connection line connecting the first line and the third line; and
a second connection line connecting the first line and the fourth line,
wherein, based on at least one mode for adjusting a temperature of a vehicle interior and a temperature of the battery module, the valve module is configured to control a flow of the coolant by selectively connecting the first line, the second line, the third line, the fourth line, the first connection line, and the second connection line.

2. The heat pump system of claim 1, wherein:
a first end of the first connection line is connected to the first line between the radiator and the electrical component;
a second end of the first connection line is connected to the third line at a downstream end of the condenser;
a first end of the second connection line is connected to the first line at a downstream end of the electrical component; and
a second end of the second connection line is connected to the fourth line at an upstream end of the second chiller.

3. The heat pump system of claim 2, wherein the at least one mode comprises:
a first mode for cooling the vehicle interior;
a second mode for cooling the vehicle interior, and for cooling the electrical component and the battery module by using the coolant;
a third mode for cooling and dehumidifying the vehicle interior, for cooling the electrical component by using the coolant, and for cooling the battery module by using the coolant heat-exchanged with a refrigerant;
a fourth mode for heating the vehicle interior, and for recollecting an ambient air heat, a waste heat of the electrical component, and a waste heat of the battery module;
a fifth mode for heating and dehumidifying the vehicle interior, and for recollecting the waste heat of the battery module; and
a sixth mode for heating and dehumidifying the vehicle interior, and for heating the battery module,
wherein a cooling level in the first mode is higher than a cooling level in the second to sixth modes.

4. The heat pump system of claim 3, wherein, in the first mode:
the first line connected to the radiator is connected, by the valve module, to the first line connected to the electrical component and to the third line connected to the condenser, respectively, so that the coolant cooled in the radiator is introduced into the electrical component and the condenser, respectively;
the second line is configured to form an independent closed circuit by the valve module, so that the coolant circulates along the second line and sequentially passes through the battery module and the first chiller;
a portion of the third line extending from the valve module through the heating core to the first connection line is configured to be closed;
the fourth line is configured to form an independent closed circuit by the valve module, so that the coolant circulates along the fourth line and sequentially and passes through the cooling core and the second chiller;
the first connection line interconnects the third line and the first line, so that the coolant flowing along the third line from the condenser is introduced into the first line connected to the radiator; and
a flow of the coolant flowing through the second connection line is stopped.

5. The heat pump system of claim 3, wherein, in the second mode:
the first line, the second line, and the third line are interconnected by the valve module, so that the coolant cooled in the radiator is introduced into the electrical component and the battery module;
the fourth line is configured to form an independent closed circuit by the valve module, so that the coolant circulates along the fourth line and sequentially passes through the cooling core and the second chiller;
the first connection line interconnects the third line and the first line, so that a partial coolant among the coolant flowing along the third line from the condenser is introduced into the first line connected to the radiator, or a partial coolant among the coolant introduced into the radiator from the electrical component along the first line is introduced into the third line connected to the heating core; and
a flow of the coolant flowing through the second connection line is stopped.

6. The heat pump system of claim 3, wherein, in the third mode:
the first line and the third line are interconnected by the valve module, so that the coolant cooled in the radiator is introduced into the electrical component, the condenser, and the heating core;
the second line is configured to form an independent closed circuit by the valve module, so that the coolant circulates along the second line and sequentially passes through the battery module and the first chiller;
the fourth line is configured to form an independent closed circuit by the valve module, so that the coolant circulates along the fourth line and sequentially passes through the cooling core and the second chiller;
the first connection line interconnects the third line and the first line, so that a partial coolant among the coolant flowing along the third line from the condenser is introduced into the first line connected to the radiator, or a partial coolant among the coolant introduced into the radiator from the electrical component along the first line is introduced into the third line connected to the heating core; and
the coolant stops flowing through the second connection line.

7. The heat pump system of claim 3, wherein, in the fourth mode:
the first line connected to the radiator and the fourth line connected to the second chiller are connected, by the valve module, to the first line connected to the electrical component, so that the coolant having passed through the radiator and the coolant having passed through the second chiller are introduced into the electrical component;
a portion of the fourth line extending from the valve module to the second connection line via the cooling core is configured to be closed;
the second line is configured to form an independent closed circuit by the valve module, so that the coolant circulates along the second line and sequentially passes through the battery module and the first chiller;
the third line is configured to form an independent closed circuit by the valve module, so that the coolant circulates along the third line and sequentially passes through the condenser and the heating core;
a flow of the coolant flowing through the first connection line is stopped; and
the second connection line interconnects the first line and the fourth line so that a partial coolant among the coolant flowing along the first line from the electrical component is introduced into the second chiller.

8. The heat pump system of claim 3, wherein, in the fifth mode:
the first line is configured to be closed by the valve module;
the second line and the fourth line are connected by the valve module, so that the coolant circulates to sequentially pass through the battery module, the first chiller, the cooling core, and the second chiller;
the third line is configured to form an independent closed circuit by the valve module, so that the coolant circulates and sequentially passes through the condenser and the heating core along the third line; and
the coolant stops flowing through the first connection line and the second connection line.

9. The heat pump system of claim 3, wherein, in the sixth mode:
the first line is configured to be closed by the valve module;
the second line and the third line are connected by the valve module, so that the coolant circulates and sequentially passes through the condenser, the heating core, the battery module, and the first chiller;
the fourth line is configured to form an independent closed circuit by the valve module, so that the coolant circulates along the fourth line and sequentially passes through the cooling core and the second chiller; and
a flow of the coolant flowing through the first connection line and the second connection line is stopped.

10. The heat pump system of claim 1, wherein the valve module comprises:
a first port to which the first end of the first line is connected;
a second port to which the second end of the first line is connected;
a third port to which the first end of the second line is connected;
a fourth port to which the second end of the second line is connected;
a fifth port to which the first end of the third line is connected;
a sixth port to which the second end of the third line is connected;
a seventh port to which the first end of the fourth line is connected; and
an eighth port to which the second end of the fourth line is connected.

11. The heat pump system of claim 1, further comprising:
a second water pump provided on the second line;
a third water pump provided on the third line; and
a fourth water pump provided on the fourth line.

12. The heat pump system of claim 11, wherein, in the at least one mode, at least two water pumps, among the first water pump, the second water pump, the third water pump, and the fourth water pump, which are provided on lines interconnected by the valve module, are configured to operates at different rotation speeds to control the flow of the coolant.

13. The heat pump system of claim 11, wherein the first water pump, the second water pump, the third water pump, and the fourth water pump are configured as pumps having different pumping heads, to control the flow of the coolant in the at least one mode.

14. The heat pump system of claim 1, wherein an electric heater is further provided on the third line, and the coolant flowing along the third line sequentially passes through the condenser and the electric heater.

15. The heat pump system of claim 1, wherein an autonomous driving controller is provided on the second line.

16. A heat pump system for a vehicle, comprising:
a valve module including a plurality of ports through which a coolant is introduced or discharged;
a first line having opposite ends connected to the valve module and to which a radiator, an electrical component, and a first water pump are connected;
a second line having opposite ends connected to the valve module and to which a battery module and a first chiller are connected;
a third line having opposite ends connected to the valve module and to which a heating core and a condenser are connected;
a fourth line having opposite ends connected to the valve module and to which a cooling core and a second chiller are connected;
a first connection line connecting the first line and the third line; and
a second connection line connecting the first line and the fourth line,
wherein the valve module is configured to selectively connect the first to fourth lines and the first and second connection lines based on at least one operation mode for adjusting a temperature of a vehicle interior and a temperature of the battery module.

17. The heat pump system of claim 16, wherein the at least one operation mode includes a first mode, and in the first mode, the valve module is configured to:
connect the first line to the radiator, the electrical component, and the third line connected to the condenser such that coolant cooled in the radiator flows into the electrical component and the condenser,
form an independent closed circuit along the second line to circulate coolant through the battery module and the first chiller,
form an independent closed circuit along the fourth line to circulate coolant through the cooling core and the second chiller,
interconnect the third line and the first line via the first connection line to return coolant from the condenser to the radiator, and
block coolant flow through the second connection line.

18. The heat pump system of claim 16, wherein, the at least one operation mode includes a second mode, and in the second mode, the valve module is configured to:
interconnect the first line, second line, and third line such that coolant cooled in the radiator flows to the electrical component and the battery module,
form an independent closed circuit along the fourth line for circulating coolant through the cooling core and the second chiller,
interconnect the third line and the first line via the first connection line to allow partial coolant exchange between the condenser and the radiator, and
block coolant flow through the second connection line.

19. The heat pump system of claim 16, wherein the at least one operation mode includes a third mode, in the third mode, the valve module is configured to:
interconnect the first line and third line to direct coolant cooled in the radiator into the electrical component, condenser, and heating core,
form an independent closed circuit along the second line for circulating coolant through the battery module and the first chiller,
form an independent closed circuit along the fourth line for circulating coolant through the cooling core and the second chiller,
interconnect the third line and the first line via the first connection line for partial coolant exchange between the condenser and the heating core, and
block coolant flow through the second connection line.

20. The heat pump system of claim 16, wherein the at least one operation mode includes a fourth mode, in the fourth mode, the valve module is configured to:
connect the first line from the radiator and the fourth line from the second chiller to the electrical component,
close a portion of the fourth line extending to the second connection line via the cooling core,
form an independent closed circuit along the second line for circulating coolant through the battery module and the first chiller,
form an independent closed circuit along the third line for circulating coolant through the condenser and the heating core,
block coolant flow through the first connection line, and
interconnect the first and fourth lines via the second connection line to direct partial coolant flow from the electrical component to the second chiller.
